(19) United States
(12) Patent Application Publication
(10) Pub. No.: US 2007/0007759 A1
(43) Pub. Date: Jan. 11, 2007

(54) Trailer having reduced weight beam construction

(75) Inventor: Brian C. Lemmons, Katy, TX (US)

Correspondence Address: SMITH IP SERVICES, P.C., 660 NORTH CENTRAL EXPRESSWAY, SUITE 230, PLANO, TX, 75074, US

(73) Assignee: Vantage Trailers, Inc.

(21) Appl. No.: 11/176,037

(22) Filed: Jul. 7, 2005

(51) Int. Cl. B62D 21/00; B62D 63/06

(52) U.S. Cl. 280/789

(57) ABSTRACT

A trailer having a reduced weight beam construction. A beam assembly for an undercarriage frame of a trailer includes at least one panel having opposing outer shells and multiple internal webs interconnecting the outer shells. A trailer includes a bed, a tractor connection, a suspension assembly and a single beam assembly supporting the bed and extending between the suspension assembly and the tractor connection.

### BACKGROUND

The present invention relates generally to wheeled vehicle construction and, in an embodiment described herein, more particularly provides a trailer having a reduced weight beam construction.

It is very beneficial to be able to reduce the tare weight of a trailer used commercially to haul loads. For example, bridge laws and other regulations limit the gross weight of over-the-road vehicles. Thus, if the tare weight can be reduced, the weight of cargo can be increased, thereby resulting in more efficient and economical hauling operations.

Trailers typically used in commercial hauling operations have an undercarriage frame which is very heavy. It will be appreciated that the tare weight of a trailer could be reduced by reducing the weight of the undercarriage frame. Preferably, this reduction in the frame's weight would not result in any reduced strength of the frame, so that the cargo weight can be thereby increased.

Therefore, it may be seen that improvements are needed in the art of trailer construction. It is an object of the present invention to provide such improvements.

### SUMMARY

In carrying out the principles of the present invention, a reduced weight trailer construction is provided which solves at least one problem in the art. One example is described below in which a specially constructed beam assembly is used to reduce the weight of the trailer. Another example is described below in which the trailer is constructed in a manner which utilizes only a single beam assembly to support a bed of the trailer.

In one aspect of the invention, a beam assembly for an undercarriage frame of a trailer is provided. The beam assembly includes at least one panel having opposing outer shells. Multiple internal webs interconnect the outer shells.

In another aspect of the invention, a trailer is provided which includes a bed, a tractor connection, and a suspension assembly. A single beam assembly supports the bed and extends between the suspension assembly and the tractor connection.

In yet another aspect of the invention, a trailer is provided which includes a bed and a beam assembly supporting the bed. The beam assembly includes at least one panel having opposing outer shells and multiple internal webs interconnecting the outer shells.

These and other features, advantages, benefits and objects of the present invention will become apparent to one of ordinary skill in the art upon careful consideration of the detailed description of representative embodiments of the invention hereinbelow and the accompanying drawings, in which similar elements are indicated in the various figures using the same reference numbers.

### BRIEF DESCRIPTION OF THE DRAWINGS

FIG. 1 is a top isometric view of a trailer embodying principles of the present invention;

FIG. 2 is a bottom isometric view of the trailer of FIG. 1;

FIG. 3 is a cross-sectional view of a beam assembly of the trailer, taken along line 3-3 of FIG. 2;

FIG. 4 is an isometric view of a panel used in the beam assembly;

FIG. 5 is a cross-sectional view of the panel, taken along line 5-5 of FIG. 4;

FIG. 6 is an isometric view of a bed support brace of the trailer;

FIG. 7 is a cross-sectional view of an arm of the bed support brace, taken along line 7-7 of FIG. 6;

FIG. 8 is a cross-sectional view of a bed side rail, taken along line 8-8 of FIG. 2; and

FIGS. 9 & 10 are schematic cross-sectional views of alternate configurations of beam assemblies which may be used in the trailer of FIG. 1.

### DETAILED DESCRIPTION

It is to be understood that the various embodiments of the present invention described herein may be utilized various configurations, without departing from the principles of the present invention. The embodiments are described merely as examples of useful applications of the principles of the invention, which is not limited to any specific details of these embodiments.

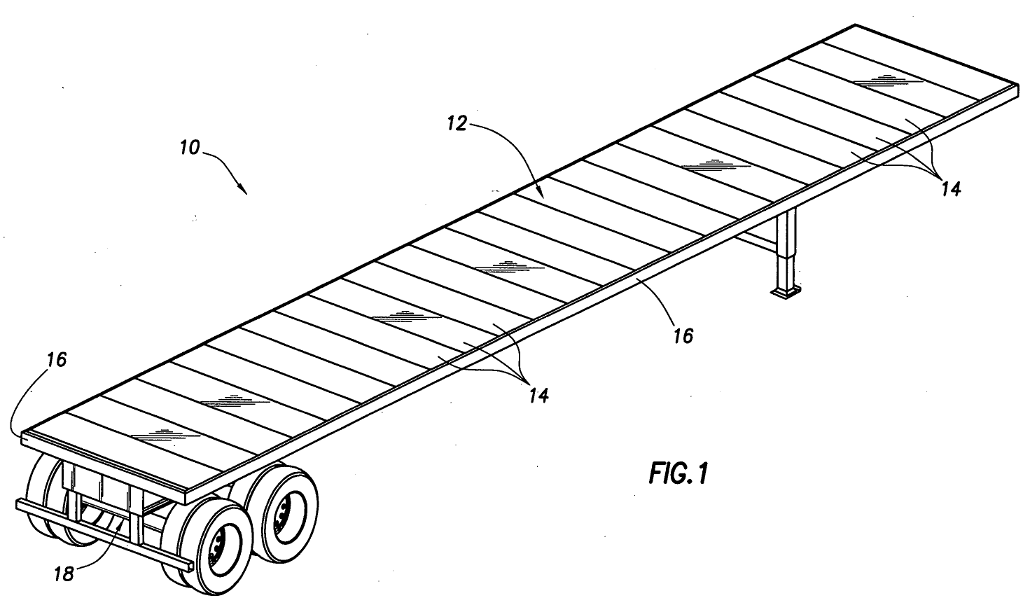

Representatively illustrated in FIG. 1 is a trailer 10 which embodies principles of the present invention. The trailer 10 is uniquely constructed to have reduced weight as compared to conventional trailers.

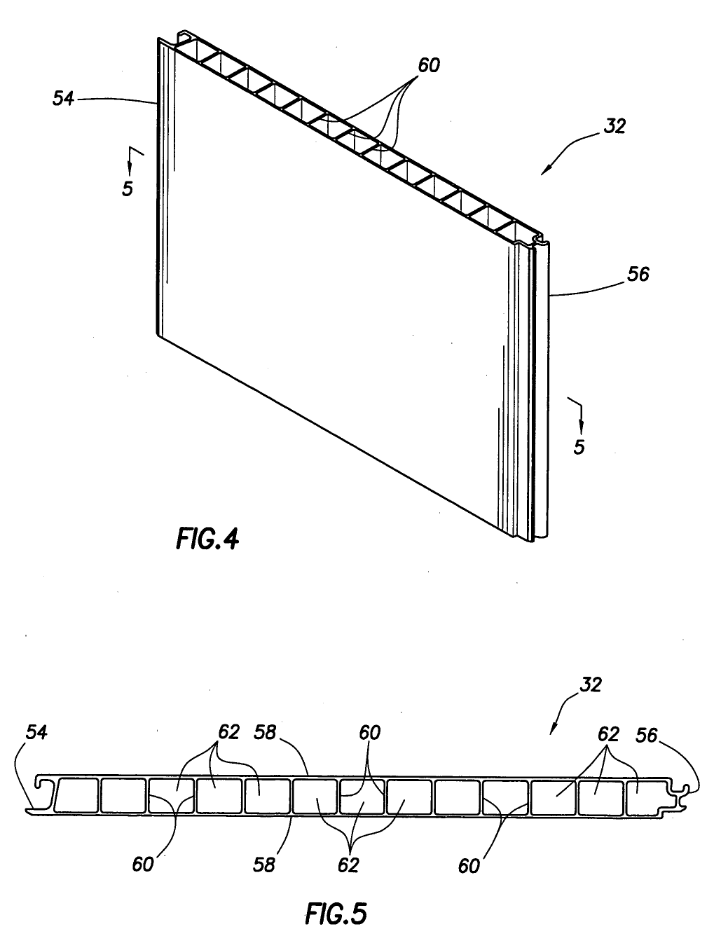

As depicted in FIG. 1, the trailer 10 includes a floor or bed 12 which is made up of multiple interconnected laterally extending panels 14. Preferably, the panels 14 are formed from extruded aluminum alloy, as described more fully below and illustrated in FIGS. 4 & 5.

The panels 14 are preferably welded to each other on top of their interconnecting edges (i.e., on top of the bed 12). The panels 14 may also, or alternatively, be adhesively bonded and/or mechanically fastened to each other along their interconnecting edges.

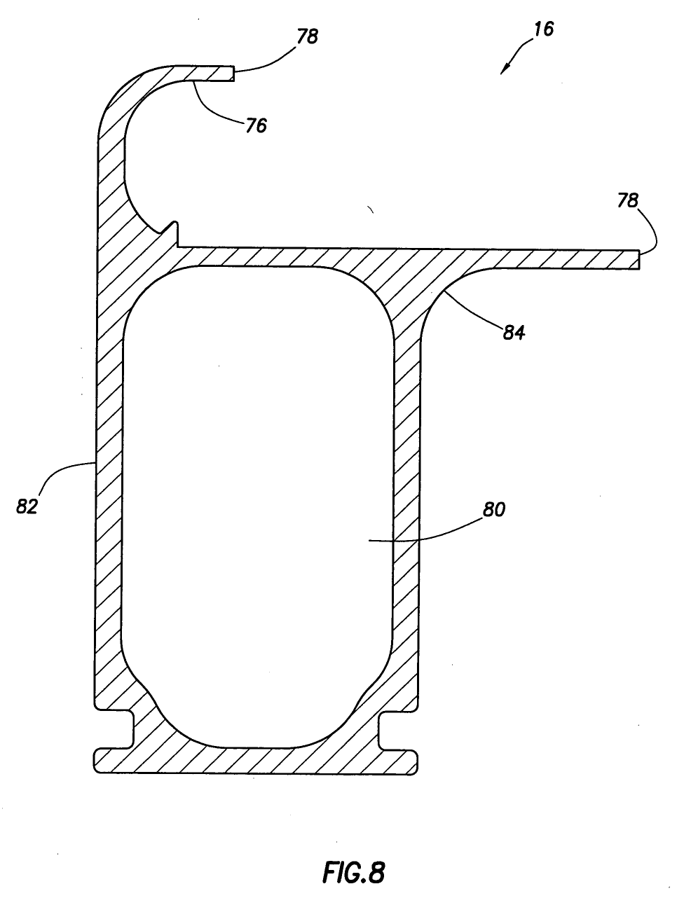

A bed side rail 16 is attached to each side of the interconnected panels 14. The rail 16 is also preferably formed from an extruded aluminum alloy, as described more fully below and illustrated in FIG. 8.

The trailer 10 does not have side walls extending upwardly from the bed 12, and so the trailer is of the type known as a flat bed trailer. It should be understood that the principles of the invention are not limited to use in flat bed trailers, since other types of trailers, such as dump trailers, enclosed box trailers, etc., could also incorporate principles of the invention.

The trailer 10 also includes a suspension assembly 18 of the type having axles, air springs, brakes, torque arms, etc. for suspending the bed 12 above a road surface on which the trailer is used. In substantial part, the suspension assembly 18 is conventional, and so it will not be described in further detail, and certain details of the suspension assembly are not shown in the drawings for illustrative clarity.

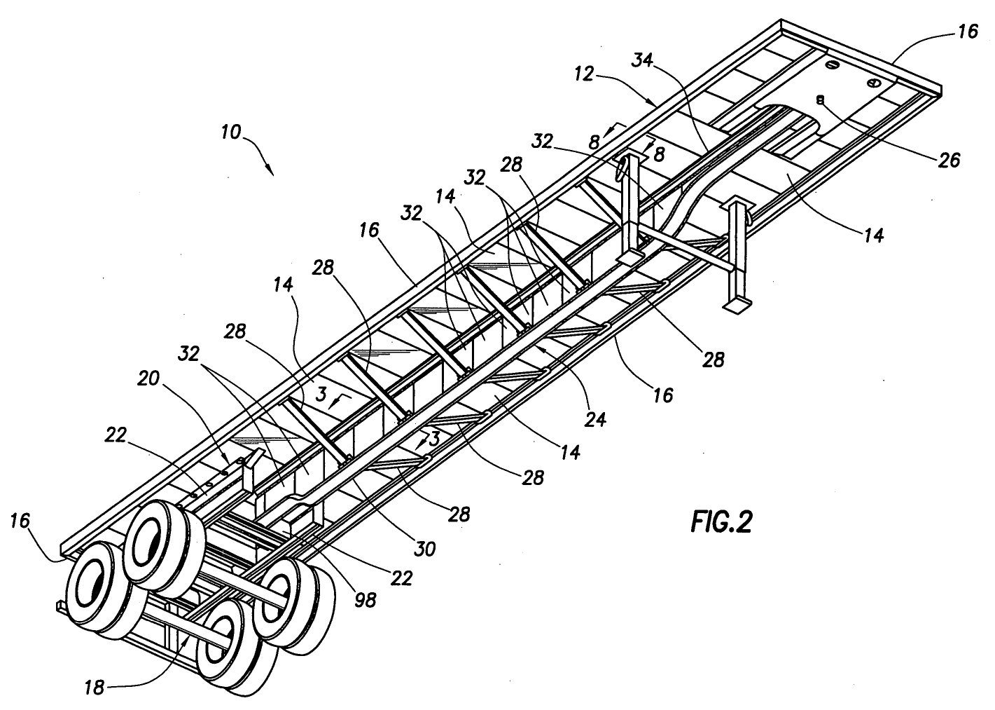

Referring additionally now to FIG. 2, a bottom side of the trailer 10 is representatively illustrated. In this view, the manner in which the bed 12 is supported by an undercarriage frame 20 of the trailer 10 can be seen.

The frame 20 includes two parallel longitudinally extending frame rails 22 of the suspension assembly 18, and a single centrally positioned longitudinally extending beam assembly 24. The beam assembly 24 extends between the suspension assembly 18 and a tractor connection 26 at a forward end of the trailer 10. At a rear end of the beam assembly 24, the beam assembly is connected to one of multiple crossmembers 98 which connect the frame rails 22 to each other.

The use of the single beam assembly 24 is a unique feature of the trailer 10. In conventional trailers, dual beams are typically used to support a bed and interconnect a rear suspension assembly to a tractor connector. The present applicant has devised a unique manner of utilizing only the single light weight beam assembly 24, while still providing sufficient support for the bed 12, thereby significantly reducing the overall weight of the trailer 10.

Bed support braces 28 extend diagonally between a bottom flange 30 of the beam assembly 24 and the lateral side rails 16 on either side of the bed 12. The braces 28 are preferably longitudinally spaced apart and welded to the bottom flange 30 and lateral side rails 16, thereby providing a relatively strong structure with the beam assembly 24 and bed 12, so that substantial loads may be supported on the bed. Note that other fastening means (e.g., mechanical fasteners, adhesive bonding, etc.) may be used in place of, or in addition to, welding if desired to secure the braces 28 to the bottom flange 30 and side rails 16.

In another unique feature of the trailer 10, the beam assembly 24 includes multiple interconnected vertically extending panels 32. The panels 32 are preferably formed from an extruded aluminum alloy and are preferably similar to the panels 14 of the bed 12.

The panels 32 are preferably welded to each other along their interconnecting edges, but other fastening means (such as mechanical fasteners, adhesive bonding, etc.) may be used in place of, or in addition to, welding if desired. The bottom flange 30 is preferably welded to a lower end of the interconnected panels 32, and a top flange 34 is preferably welded to an upper end of the panels, although other fastening means may be used if desired.

The top flange 34 extends longitudinally beneath most of the laterally extending panels 14 of the bed 12. Preferably, the top flange 34 is welded to a bottom surface of each of the panels 14 which the top flange supports, although other fastening means may be used if desired. It is also preferred that the welding used to secure the panels 14 to the top flange 34 does not extend into the interconnecting edges between the panels (i.e., the top flange is skip welded to the panels), but other welding techniques may be used if desired.

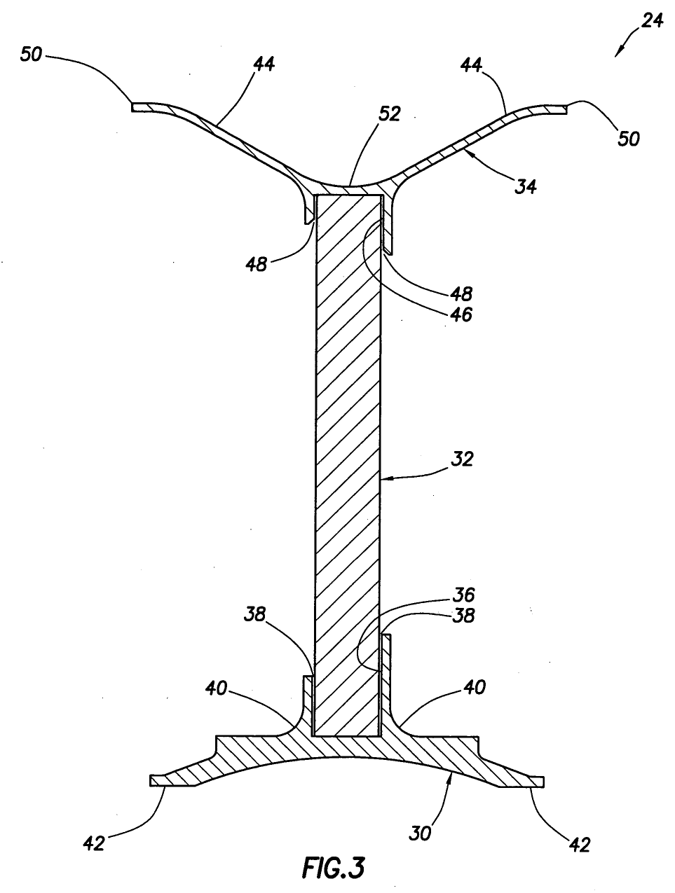

Referring additionally now to FIG. 3, an enlarged cross-sectional view of the beam assembly 24 is representatively illustrated apart from the remainder of the trailer 10. In this view the manner in which the beam assembly 24 is constructed may be more clearly seen.

The bottom flange 30 includes an upper longitudinally extending slot or recess 36 in which the lower ends of the panels 32 are received. Preferably, the panels 32 are welded to the bottom flange 30 at locations 38 at upper ends of the recess 36.

Lower ends of the braces 28 are received in radiused corners 40 of the bottom flange 30. The lower ends of the braces 28 are preferably welded to the bottom flange 30 in the corners 40.

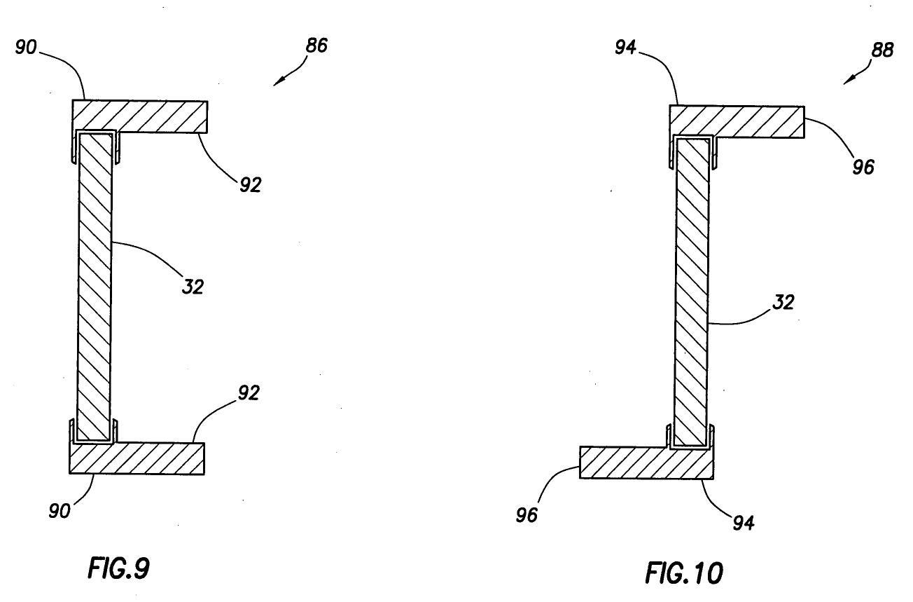

Note that the bottom flange 30 has laterally extending legs 42 which are symmetrical. The top flange 34 also has laterally extending legs 44 which are symmetrical. The beam assembly 24 thus has a generally I-shaped cross-section, but it should be clearly understood that other cross-sectional shapes may used for the beam assembly in keeping with the principles of the invention (see FIGS. 9 & 10).

The top flange 34 also includes a lower longitudinally extending slot or recess 46 in which the upper ends of the panels 32 are received. Preferably, the panels 32 are welded to the top flange 34 at locations 48 at lower ends of the recess 46.

The top flange 34 is preferably welded to the panels 14 of the bed 12 at locations 50 at outer ends of the flange legs 44. Note that the top flange 34 is concave on its upper surface 52 between the weld locations 50. This configuration aids in distributing the load transfer between the beam assembly 24 and the panels 14 of the bed 12. The laterally inclined legs 44 of the top flange 34 provide for a more rigid structural connection between the panels 32 of the beam assembly 24 and the panels 14 of the bed 12.

Each of the top and bottom flanges 34, 30 is preferably formed of an extruded aluminum alloy. However, other manufacturing processes and materials may be used in keeping with the principles of the invention.

The panel 32 extends vertically between the top and bottom flanges 34, 30. In the terminology used for convention structural I-beams, the panel 32 thus forms a web interconnecting the flanges 30, 34.

Referring additionally now to FIG. 4, an isometric view of one of the panels 32 is representatively illustrated apart from the remainder of the beam assembly 24. In this view it may be seen that the panel 32 is generally vertically oriented and has vertical interlocking edges 54, 56 for connecting multiple panels to each other.

A cross-sectional view of the panel 32 is representatively illustrated in FIG. 5. In this view it may be more clearly seen that the panel 32 has opposing outer shells 58 which are interconnected by multiple internal webs 60.

The webs 60 thus divide the interior of the panel 32 into multiple separate internal cavities 62. These cavities 62 may remain empty when the panel 32 is used in the beam assembly 24, or the cavities could have a substance (such as rigid foam, polymer materials, etc.) therein to strengthen the panel or to at least outwardly support the outer shells 58 between the webs 60.

The interlocking edges 54, 56 may be considered as female and male types, respectively. The panels 32 may be connected to each other with the interlocking edges 54, 56 to aid in holding the panels together while they are welded to each other. Of course, other types of interconnecting edges may be used on the panels 32 (whether or not the edges are of the interlocking type), and other fastening means may be used for attaching the panels to each other.

It will be readily appreciated that, with the relatively complex cross-sectional form of the panel 32, an extrusion process would be well suited for manufacturing the panel. For its light weight and other desirable properties, an aluminum alloy would be a suitable material for use in the panel 32. However, other manufacturing processes and materials may be used for forming the panel 32 in keeping with the principles of the invention.

As depicted in FIG. 4, when the panel 32 is used in the beam assembly 24 in its vertical orientation, the webs 60 will extend vertically, and the interlocking edges 54, 56 will also extend vertically. The panels 14 of the bed 12 may be constructed the same as, or similar to, the panels 32 of the beam assembly 24, in which case the webs 60 of the panels 14 will extend laterally. Note that the cavities 62 in the panels 14 could be filled with a substance to support the upper outer shell 58 between the webs 60 to thereby resist puncture from objects supported on the bed 12 in use.

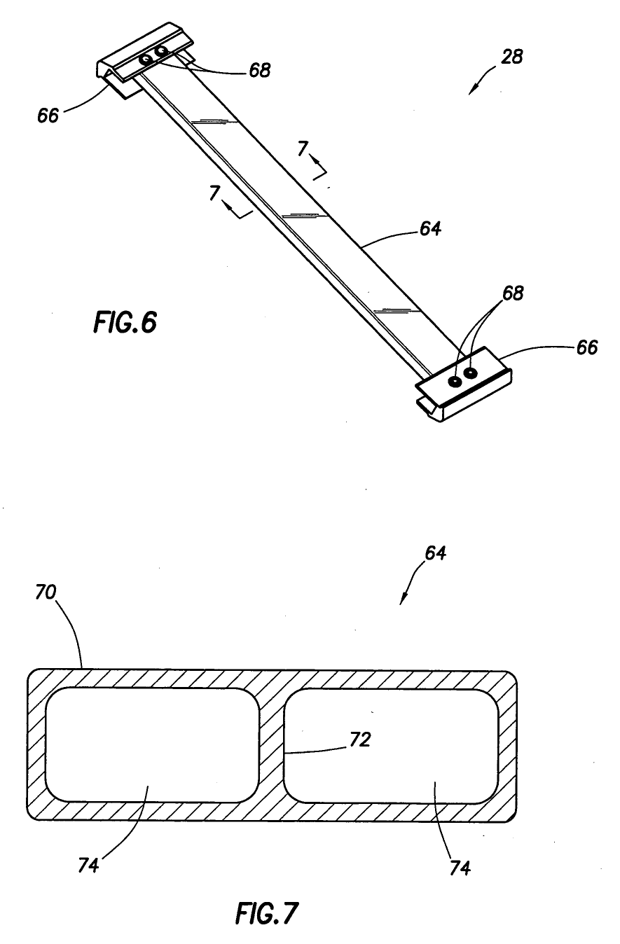

Referring additionally now to FIG. 6, one of the bed support braces 28 is representatively illustrated apart from the remainder of the trailer 10. In this view it may be clearly seen that the brace 28 includes an arm 64 with connectors 66 attached at each end.

The connectors 66 may be similarly configured, as depicted in FIG. 6, or they may be differently configured to conform to different attachment areas on the side rails 16 and bottom flange 30. Preferably, the connectors 66 and the arm 64 are each formed of an extruded aluminum alloy, but other manufacturing processes and materials may be used in keeping with the principles of the invention.

The connectors 66 are attached to the arm 64 using mechanical fasteners 68 (such as bolts, screws, rivets, dowels, pins, etc.). The connectors 66 could instead, or in addition, be attached to the arm 64 by welding, adhesive bonding, and/or any other fastening means. For example, the connectors 66 could be integrally formed with the arm 64.

Referring additionally now to FIG. 7, a cross-sectional view of the arm 64 is representatively illustrated. In this view it may be seen that the arm 64 includes an outer rectangular shell 70 and an internal web 72 separating two internal cavities 74.

It should be understood that the arm 64 could be differently configured if desired. For example, the arm 64 could have a circular rather than rectangular cross-section, greater or fewer numbers of cavities 74 could be provided using greater or fewer numbers of internal webs 72, etc. The cavities 74 could have a substance therein to strengthen the arm 64 or at least outwardly support the shell 70 if desired.

A cross-sectional view of the side rail 16 is representatively illustrated in FIG. 8. In this view it may be seen that the side rail 16 includes a longitudinally extending slot or recess 76 for receiving ends of the panels 14 (or side edges of the panels when the rail is used at forward and rear ends of the bed 12) therein.

The side rail 16 is preferably formed of an extruded aluminum alloy, although other manufacturing processes and materials may be used if desired. An internal cavity 80 is formed in the side rail 16, and this cavity may be filled with a substance to strengthen the rail or to at least outwardly support an outer shell 82 of the rail.

Of course, other configurations of the side rail 16 may be used in keeping with the principles of the invention. For example, multiple internal cavities 80, differently shaped outer shells 82, etc., could be used if desired.

The side rail 16 is preferably welded to the panels 14 at locations 78 straddling the recess 76. On the bottom side of the lateral ends of the panels 14, the side rail 16 may be skip welded to the panels, so that the weld does not extend into the interconnecting edges of the panels. Other fastening means (such as mechanical fasteners, adhesive bonding, etc.) may be used instead of, or in addition to, welding to attach the side rail 16 to the panels 14.

A radiused corner 84 is provided on the side rail 16 for attachment of the bed support braces 28. The upper connectors 66 of the braces 28 may be welded to the side rail 16 in the corner 84 or other fastening means (such as mechanical fasteners, adhesive bonding, etc.) may be used instead of, or in addition to, welding to attach the side rail to the braces.

Referring additionally now to FIGS. 9 & 10, schematic cross-sectional views are representatively illustrated of alternate configurations of beam assemblies 86, 88 which may be used in place of the beam assembly 24. As discussed above, it is not necessary for the flanges 30, 34 of the beam assembly 24 to be symmetrical, and the beam assemblies 86, 88 are depicted in FIGS. 9 & 10 to demonstrate two other configurations which may be used.

In FIG. 9, the beam assembly 86 includes flanges 90, each of which has a leg 92 extending laterally in the same direction as the leg of the other flange. In this manner, the beam assembly 86 is similar in shape to conventional structural beams known as C-channels.

In FIG. 10, the beam assembly 88 includes flanges 94, each of which has a leg 96 extending laterally in an opposite direction relative to the leg of the other flange. In this manner, the beam assembly 88 is similar in shape to conventional structural beams known as Z-channels.

Thus, it will be readily appreciated that a wide variety of different configurations may be used for the beam assembly 24 in keeping with the principles of the invention. For example, instead of the beam assembly 24 including multiple vertically oriented panels 32, one or more panels could be horizontally oriented in the beam assembly between the flanges 30, 34. In that case, the webs 60 in the panel 32 would extend horizontally instead of vertically. If only a single horizontally oriented panel 32 is used in the beam assembly 24, the step of welding multiple panels to each other to form the web of the beam assembly could be eliminated.

It is also not necessary for the web of the beam assembly 24 to be made up of one or more of the specific panels 32 described above. Differently configured panels or other structural elements (such as corrugated panels, lattice structures, etc.) could be used in keeping with the principles of the invention.

Those skilled in the art will readily appreciate that the trailer 10 described above provides many advantages over prior trailer designs, including greatly reduced weight. One factor contributing to this weight reduction is that the unique construction of the trailer 10 eliminates the need for multiple laterally extending crossmembers spaced apart longitudinally above multiple beams to support longitudinally extending plates forming a bed of the trailer. Instead, the trailer 10 has the laterally extending panels 14 positioned directly over the beam assembly 24, with no crossmembers between the beam assembly and the panels. Thus, the crossmembers (and their associated weight) are eliminated.

Of course, a person skilled in the art would, upon a careful consideration of the above description of representative embodiments of the invention, readily appreciate that many modifications, additions, substitutions, deletions, and other changes may be made to these specific embodiments, and such changes are within the scope of the principles of the present invention. Accordingly, the foregoing detailed description is to be clearly understood as being given by way of illustration and example only, the spirit and scope of the present invention being limited solely by the appended claims and their equivalents.

What is claimed is:

1. A beam assembly for an undercarriage frame of a trailer, the beam assembly comprising:
at least one panel having opposing outer shells and multiple internal webs interconnecting the outer shells.

2. The beam assembly of claim 1, wherein the panel is made of an extruded aluminum alloy.

3. The beam assembly of claim 1, wherein the panel further includes multiple internal cavities separated by the internal webs.

4. The beam assembly of claim 1, wherein the panel forms a vertical web of the beam assembly.

5. The beam assembly of claim 4, wherein top and bottom flanges are attached to the vertical web.

6. The beam assembly of claim 1, wherein the beam assembly includes multiple panels.

7. The beam assembly of claim 6, wherein each of the panels has at least one interlocking edge for connecting the panel to at least one adjacent panel.

8. The beam assembly of claim 7, wherein the interlocking edges extend vertically when the beam assembly is in use in the trailer undercarriage frame.

9. The beam assembly of claim 7, wherein the interlocking edges are joined to each other by welds.

10. The beam assembly of claim 7, wherein the interlocking edges are joined to each other by adhesive bonding.

11. The beam assembly of claim 1, wherein the panel webs extend vertically when the beam assembly is in use in the trailer undercarriage frame.

12. The beam assembly of claim 1, wherein the panel webs extend horizontally when the beam assembly is in use in the trailer undercarriage frame.

13. A trailer, comprising:
a bed;
a tractor connection;
a suspension assembly; and
a single beam assembly supporting the bed and extending between the suspension assembly and the tractor connection.

14. The trailer of claim 13, wherein the beam assembly includes at least one panel having opposing outer shells and multiple internal webs interconnecting the outer shells.

15. The trailer of claim 14, wherein the panel is made of an extruded aluminum alloy.

16. The trailer of claim 14, wherein the panel further includes multiple internal cavities separated by the internal webs.

17. The trailer of claim 14, wherein the panel forms a vertical web of the beam assembly.

18. The trailer of claim 17, wherein top and bottom flanges are attached to the vertical web.

19. The trailer of claim 14, wherein the beam assembly includes multiple panels.

20. The trailer of claim 19, wherein each of the panels has at least one interlocking edge for connecting the panel to at least one adjacent panel.

21. The trailer of claim 20, wherein the interlocking edges extend vertically in the beam assembly.

22. The trailer of claim 20, wherein the interlocking edges are joined to each other by welds.

23. The trailer of claim 20, wherein the interlocking edges are joined to each other by adhesive bonding.

24. The trailer of claim 14, wherein the panel webs extend vertically in the beam assembly.

25. The trailer of claim 14, wherein the panel webs extend horizontally in the beam assembly.

26. A trailer, comprising:
a bed; and
a beam assembly supporting the bed, the beam assembly including at least one panel having opposing outer shells and multiple internal webs interconnecting the outer shells.

27. The trailer of claim 26, wherein the panel is made of an extruded aluminum alloy.

28. The trailer of claim 26, wherein the panel further includes multiple internal cavities separated by the internal webs.

29. The trailer of claim 26, wherein the panel forms a vertical web of the beam assembly.

30. The trailer of claim 29, wherein top and bottom flanges are attached to the vertical web.

31. The trailer of claim 26, wherein the beam assembly includes multiple panels.

32. The trailer of claim 31, wherein each of the panels has at least one interlocking edge for connecting the panel to at least one adjacent panel.

33. The trailer of claim 32, wherein the interlocking edges extend vertically in the beam assembly.

34. The trailer of claim 32, wherein the interlocking edges are joined to each other by welds.

35. The trailer of claim 32, wherein the interlocking edges are joined to each other by adhesive bonding.

36. The trailer of claim 26, wherein the panel webs extend vertically in the beam assembly.

37. The trailer of claim 26, wherein the panel webs extend horizontally in the beam assembly.

38. The trailer of claim 26, further comprising a tractor connection, and a suspension assembly, and wherein only the single beam assembly supports the bed and extends between the suspension assembly and the tractor connection.

39. A trailer, comprising:
a bed including multiple laterally extending bed panels; and
a beam assembly supporting the bed.

40. The trailer of claim 39, wherein the bed panels have opposing outer shells and multiple internal webs interconnecting the outer shells.

41. The trailer of claim 39, wherein the bed panels are made of an extruded aluminum alloy.

42. The trailer of claim 39, wherein the bed panels include multiple internal cavities separated by internal webs.

43. The trailer of claim 39, wherein the beam assembly includes at least one beam panel forming a vertical web of the beam assembly.

44. The trailer of claim 43, wherein the beam assembly includes multiple beam panels.

45. The trailer of claim 39, wherein each of the bed panels has at least one interlocking edge for connecting the panel to at least one adjacent panel.

46. The trailer of claim 45, wherein the interlocking edges are joined to each other by welds.

47. The trailer of claim 45, wherein the interlocking edges are joined to each other by adhesive bonding.

48. The trailer of claim 39, further comprising a tractor connection, and a suspension assembly, and wherein only the single beam assembly supports the bed and extends between the suspension assembly and the tractor connection.

49. The trailer of claim 39, wherein the trailer is free of any crossmembers positioned between the beam assembly and the bed panels.

50. A trailer, comprising:
a bed; and
a beam assembly supporting the bed,
wherein the trailer is free of any crossmembers positioned between the beam assembly and the bed.

51. The trailer of claim 50, wherein the bed includes multiple laterally extending bed panels.

52. The trailer of claim 51, wherein each of the bed panels has opposing outer shells and multiple internal webs interconnecting the outer shells.

53. The trailer of claim 50, wherein the beam assembly includes at least one beam panel forming a vertical web of the beam assembly.

54. The trailer of claim 53, wherein the beam panel has opposing outer shells and multiple internal webs interconnecting the outer shells.

55. The trailer of claim 53, wherein the beam assembly includes multiple beam panels.

56. The trailer of claim 50, further comprising a tractor connection, and a suspension assembly, and wherein only the single beam assembly supports the bed and extends between the suspension assembly and the tractor connection.
